(19) United States
(12) Patent Application Publication
(10) Pub. No.: US 2009/0064027 A1
(43) Pub. Date: Mar. 5, 2009

(54) EXECUTION AND VISUALIZATION METHOD FOR A COMPUTER PROGRAM OF A VIRTUAL BOOK

(75) Inventors: Alvaro Navas Cadena, Sur Bucaramanga (CO); Freny Arley Caicedo Sierra, Sur Bucaramanga (CO); Tomas Navas Corona, Sur Bucaramanga (CO); Andres Mauricio Gordillo Solano, Sur Bucaramanga (CO); Paolo Andres Montagut Fernandez, Sur Bucaramanga (CO); Oscar Alberto Ramirez Rangel, Sur Bucaramanga (CO); Martin Ariel Rueda Meneses, Sur Bucaramanga (CO); Daniel Navas Corona, Sur Bucaramanga (CO); Jaime Villamizar Hernandez, Sur Bucaramanga (CO); Oscar Ivan Rodriguez Acevedo, Sur Bucaramanga (CO)

Correspondence Address: MERCHANT & GOULD PC, P.O. BOX 2903, MINNEAPOLIS, MN, 55402-0903, US

(73) Assignee: SYC Sistemas y Computadores S.A, Sur Bucaramanga (CO)

(21) Appl. No.: 12/200,056

(22) Filed: Aug. 28, 2008

(30) Foreign Application Priority Data
Aug. 28, 2007 (CO) 07-087997

(51) Int. Cl. G06F 3/048

(52) U.S. Cl. 715/776

(57) ABSTRACT

The application provides a method to catalogue and visualize books in a familiar manner for the user, since its graphic interface enables reading of the virtual book in a manner as similar as possible to that of a physical book. The contents of the books may be displayed literally or with commentary such as general comments, historic notes, illustrations, music and even other books. It also includes tools such as dictionaries in multiple languages and search tools in order to provide access to library materials.

The present invention is related to a method for the execution and visualization for a computer program that comprises a new format for the presentation of documentary information, interrelated in a conceptual as well as in a logical manner. In particular, the invention claimed allows the reading and consultation of information, with de advantage of linking ideas and not only literal words.

### BACKGROUND OF THE INVENTION

The virtual books systems currently existing allow the user to perform searches in determined environments, based on exact criteria, such as literal words or phrases. These types of searches are related to those carried out in formats under patents that are available in the market such as PDF, DOC, WRI, and HTML among others.

This means that a search of a criterion is done only thorough literal phrases or words, but not through searches of specific ideas. This is one of the most common inconveniences that a reader or user of virtual books can find, since a specific search result is not obtained, but one that is limited to certain phrases or words that fail to accurately describe what the user seeks to locate.

The international patent WO 2005/086133 (cited only as reference) refers to a hardware and software comprising a controller for several visualization methods and is used to perform searches through data stored in a memory device. This international patent application refers to the controllers required to carry out the information search process in a data base, based on literal phrases and/or words, so that the user can accomplish a fast and concise search, and for visualizing the results in a screen or a monitor.

Other methods for visualizing information that can be searched through a computer program related to virtual books, are described in the US patents US 2004/0201569 and US 2004/0164975 patents, which are incorporated strictly for reference's purposes.

These applications are directly related with electronic search visualization means that comprise a book-type user interface. Image visualization systems are showed, which are obtained through searches carried out in resource bases and in the Internet and then they are exposed to the user or reader in book-form visualization. These systems provide a fast and easy access for the visualization of electronic resources and besides, there are programmable through a programming application that can be adapted in accordance to the needs of each user. Through this programming, changes of dynamic or static effects can be performed, which can be applied to the system's interface mentioned in the application.

There is a great amount of virtual books available on the Internet that are characterized for being just images of the pages of the hard copies of the book arranged in documents that can be visualized in different applications. These virtual books found in the state of the art, are a useful resource T the time of carrying out a search, but they show some inconveniences such as the fact that the reading can be tedious and unpleasant in these kinds of documents, due to various factors such as the quality of the images—which is frequently deficient. Another fact affecting the reading process is that in most occasions the navigation system of these documents is not easy to use and, besides, the reader is subject to use scrollbars.

To the factors already listed above, we can add the fact that the documents mentioned are limited to show the same information that was in the hard copy book from which the virtual book found in the Internet derives, and they do not expand their scope to other resources that can be applied while carrying out a search.

The virtual book of the present invention intends to overcome the reading problems of the existing virtual books, since it allows the interrelation of ideas and even of the books among themselves, the lay out of each page is designed again for its digital version, using a font with a size an color characterized in that the reading through the screen becomes restful, relaxed and pleasant. Moreover, the application seeks to avoid the use of scrollbars to perform the respective reading and the connection of texts, Figures and ideas is carried out through links.

Internet searches, whether performed in encyclopedias or in virtual books, have become an essential tool at the time of carrying out searches. The users are always looking for novel systems that allow them to read the contents of a book and access related information that broadens the contents of such book, such as information related to paintings, musical pieces, comments, annotations, historical references and even the relationship with other books. Having this connection to other types of arts allows a more complete and extensive search, since it is not limited to the text only or to what the user is searching for, but it extends to other authors of writings or works related to the topic of interest.

One of the main obstacles that a user may find while performing a search in a book or a text, is that such a search is limited to literal words, whereas the goal to be achieved is to be able to carry out a search through concrete ideas or to link such ideas together, because when a search is done through ideas, a more precise result is attained in comparison to what the user is really searching for, regarding the ideas that are in mind and that are sought to be seen represented in the texts or articles subject matter of the search.

### SUMMARY OF THE INVENTION

The main objective of the present invention is to provide a visualization and execution method of a computer program for the search and consultation in electronic means that are linked, either by the ideas mentioned therein or by the topics in which the focus on, and that may have something in common that concerns the results of the search performed by the user.

In addition, the objective of the present invention is to facilitate searches carried out through electronic means, thus providing links between different works, whether literary, art musical and other works. In the same manner used in a specialized library, the reader has access to dictionaries from different times that allow the consultation of a word in its original context, in which the work under reference was written or carried out.

One of the main characteristics of the present invention is to provide a specialized computer program that offers an interface that is as similar as possible to a hard copy of a book, so that the navigation through the application is as natural as possible for the reader or user, and also providing a pleasant reading.

Another objective of the herein invention is to provide a virtual book in an developed environment that shows a behavior similar to that provided by a physical book, thus facilitating the user for carrying out searches through the system described in the herein application.

There are other objectives that characterize this invention, one of them is to offer a different and novel method for executing and visualizing a virtual book, overcoming the reading problems present in the existing virtual books; thus improving the ways in which searches and reading are carried out, gathering different resources in order to create a complete virtual book system which is not limited solely to literature.

Another objective of the herein invention is to teach a method based in a computer program which produces an answer depending on the action sought to be carried out through the cited method, always taking into account the search criteria of the reader or user, and showing all the possible options that may derive from the search without being limited solely to the literary works found in first instance by the computer program.

The herein invention also allows the consultation of the meaning of a word by simply double-clicking on the word subject of the search. This characteristic allows the appearance of a small book with the listing of the word's approximations and when the cursor is placed over one of the words of the list, the meaning of such word will be displayed on the visualization media.

### BRIEF DESCRIPTION OF THE DRAWINGS

The interface of the present invention intends to be as similar as possible to an actual book. This characteristic can be visualized in a better way through the drawings shown with the application. By using these drawings the advantages of the present invention may be appreciated in a clearer and more concise manner.

The drawings shown are described as follows:

FIG. 1: This Figure corresponds to a general diagram that shows the method performed when executing and visualizing the virtual book of the present invention.

FIG. 2: This Figure makes reference to the method implemented when there is a need to know the meaning of a certain word through a dictionary

FIG. 3: This Figure is related to the method that is necessary to obtain an audio result, such as the book's reading or musical works related to that work.

FIG. 4: This Figure shows a diagram of the method that has to be used to be able to leave a comment or annotation in the text that is being consulted.

FIG. 5: This Figure corresponds to the method used to close a consulted book as well as to open it in the last page consulted, at a later time.

FIG. 6: This Figure corresponds to the visualization of the virtual book's main menu, in which the work to be consulted is selected.

FIG. 7: This Figure corresponds to the menu visualization of the selected work. The different books related to the chosen work are displayed in this menu.

FIG. 8: This Figure corresponds to the visualization of the screen display of an open book, including the index of the book selected previously and from which the chapter to be consulted may be chosen.

FIG. 9: This Figure corresponds to the visualization of the screen display of the open book, which has with the typical characteristics of a physical book as well as the connection tabs through which other additional functions may be accessed, comprising the virtual book of the present invention.

FIG. 10: This Figure corresponds to the visualization of an open book as from the selection of a connection tab located on the main book.

FIG. 11: This Figure corresponds to the visualization of the dictionary, which is displayed as a small open book over the main book and it shows the word for which the user seeks its meaning.

FIG. 12: This Figure corresponds to a functional block diagram of the hardware resources used in a representative environment in which the present invention may be employed.

### DETAILED DESCRIPTION OF THE PREFERRED EMBODIMENT(S)

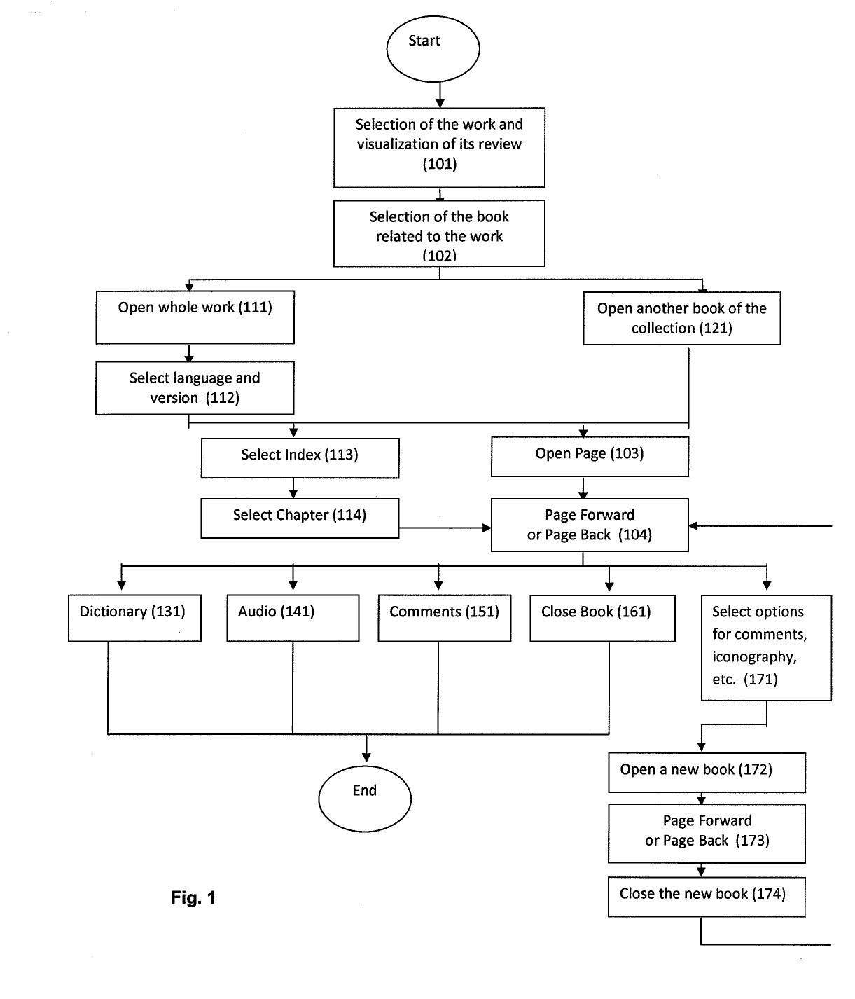

FIG. 1 shows the general method that must be developed at the time of executing and visualizing the virtual book of the present invention.

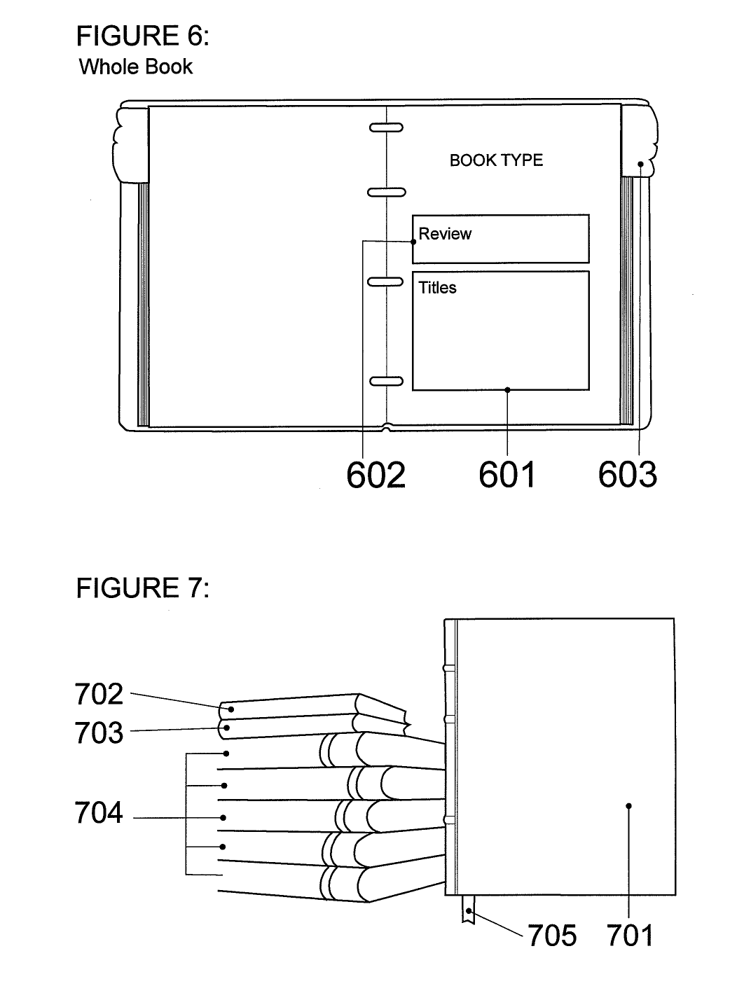

First of all, once the computer program is executed, a book is visualized as shown in FIG. 6. The next step is to select the work that is going to be consulted, with which a review of the work itself is displayed (101). Once the user has clicked to select the work subject of consultation, he proceeds to select the book related with such work (102), since the program of the present invention is not limited only to the consultation of the book containing the work, but it also allows the consultation of other books that contain topics related to such work, including other texts, musical works, iconographies, etc. This stage leads to a screen as showed in FIG. 7.

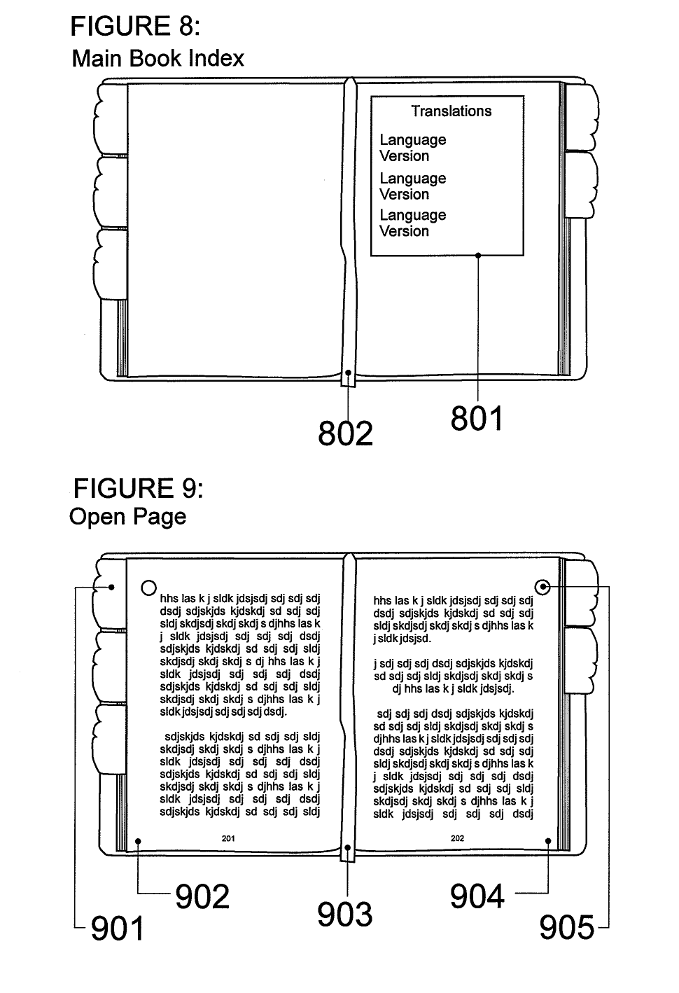

As it may be seen in FIG. 1, starting from this point, there are two possibilities. On the one hand there is the selection of the book that contains the entire work (111), just as it is showed in FIG. 8. Once this step is completed, the user selects the language and the version (112) in which he wishes to consult the work initially chosen.

Following the method, there are two options available on order to continue with the consultation. One of the options is to select the connection tab corresponding to the book's index (113) and thus, be able to go to a specific section of such book. In the index, the user finds the different chapters of the book that contain the complete work and he can select the chapter that he wishes to look up (114). The other option is to perform the reading in a normal way, as if a physical book is being consulted page by page (103). When the latter is chosen, an open book is visualized like the one shown in FIG. 9, and in order to move forward to the next page, the user must click on the lower right end and to go to the previous page he must click on the lower left end.

Another option mentioned, is the selection of another book from the collection (121), different from the book containing the entire work. Again, just as in the case of the whole work, this book can be read through the selection of the tab corresponding to the index (113) followed by the selection of the chapter (114) to be consulted, or it can be read in the regular way, page by page (103).

Thus, regardless of the option previously selected, as from this point the user proceeds with the consultation of the book. The page of the selected book is opened (103) and the consult is performed as if it was a physical book, moving pages forward and/or backwards (104).

Additionally, the invention provides a variety of tools that can be used as the reading takes place. Some of these tools are located over the text while others are distributed over the connection tabs, which are situated on the lateral ends of each page.

The dictionary is among the consultation tools that are over the text's page (131), option that allows the user to find out the meaning of any word that is in the book. This dictionary is displayed as a smaller book over the main book, just as it is represented in FIG. 11.

Another tool of the virtual book is the audio option (141), through which the reading of the text can be heard. Also, there is the alternative of writing comments or annotations (151) regarding a paragraph or a part of the book that is being consulted, is also an alternative. Lastly, the user has the option of closing the book that he is consulting (161).

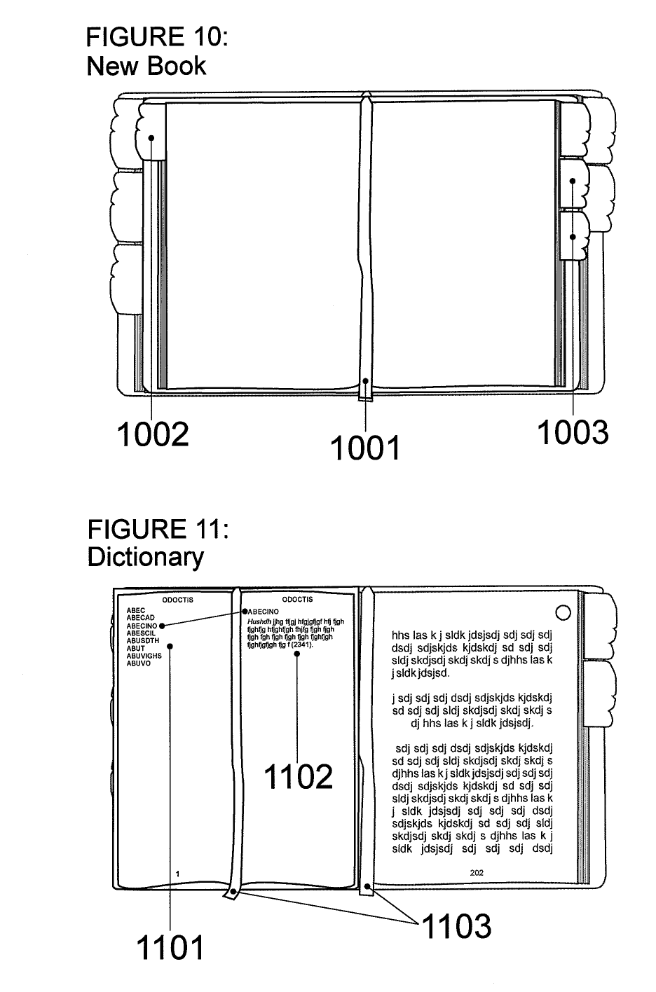

If the user decides to select one of the options represented by the tabs (171) a new book t will open (172) containing the option chosen as more specifically displayed in FIG. 10. Next, the user continues with the reading or with the consultation process of this new book by going through the pages in a forward or backward manner (173). Once the consultation of this option is finished, the book is closed (174) and the reading of the main book, which was being consulted on the first place, is resumed (104).

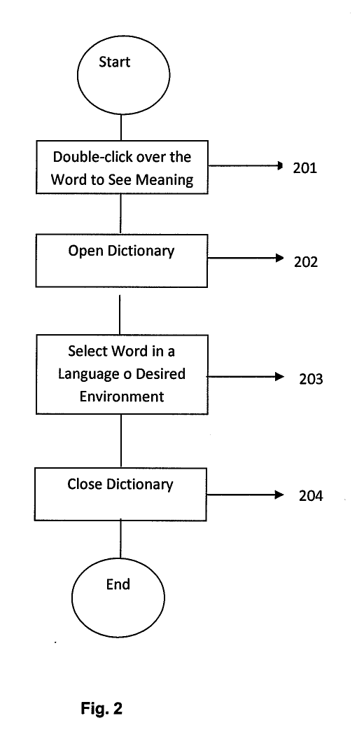

FIG. 2 shows in detail the method developed to use the dictionary option in order to search for the meaning of a particular word. The first step of this method develops when the consultation of a book is being carried out, and the user wishes to know the meaning of a word by double-clicking over such word (201). As a result of this action, a new book of a smaller size is opened which is located over the book that is being consulted. The smaller book that was opened is the dictionary (202) and once is on the screen, as visualized in FIG. 11, the user proceeds to select the word in the language or setting desired (203). Finally, when the consultation of the word is done, the dictionary is closed (204), which takes the user back to the main book he was originally reading.

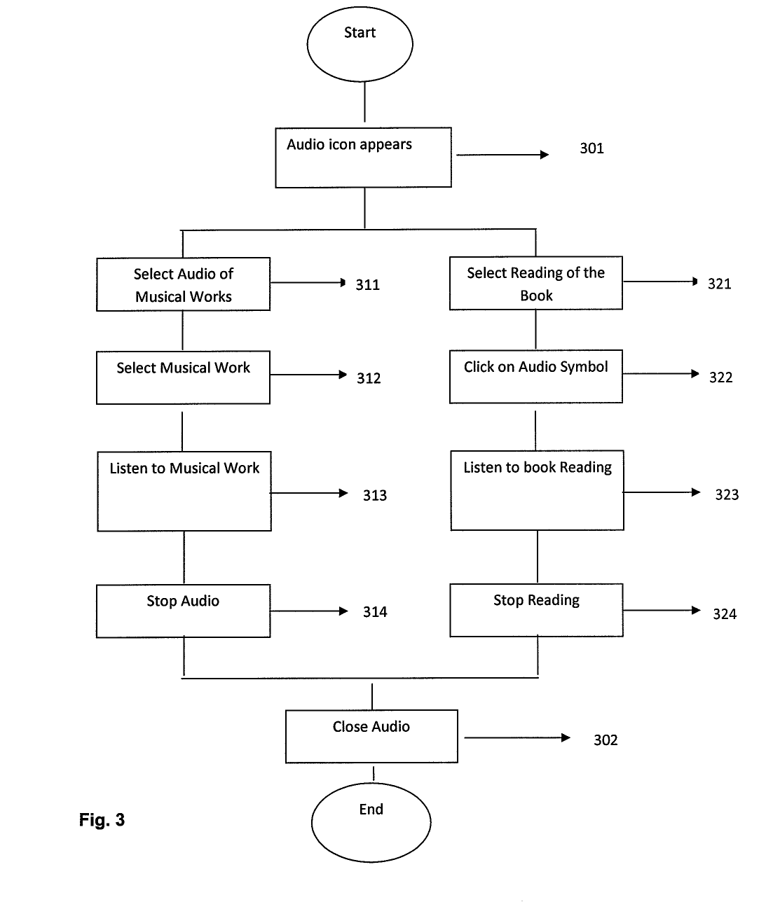

Another tool previously mentioned is the audio option, shown in FIG. 3. This Figure relates to the usage method of the audio options presented by the virtual book. First, an icon indicating the audio option (301) appears at the top end of the book that is being consulted. There are two different icons for two different options. One of these is the option of listening to musical works (311) that have any type of association with the work that is being consulted. Once the audio option for musical works is selected, the user proceeds to choose the musical work (312) that he wishes to listen. The next step is to listen to the actual musical work (313) and lastly the user shall stop the reproduction of such musical work (314).

The second option related to the audio tool is to listen to the reading of the book that is being consulted (321). This option allows the user to listen to the reading of the entire book or of a section of it, by the computer program. The method carried out here is to click over the audio symbol (322) that appears in the book, and then proceed to listen to the work's reading (323). The user can stop such reading whenever he wishes to, by clicking on the icon designed to stop the reading (324). Finally, the user proceeds to close the audio (302) and return to the book's consultation.

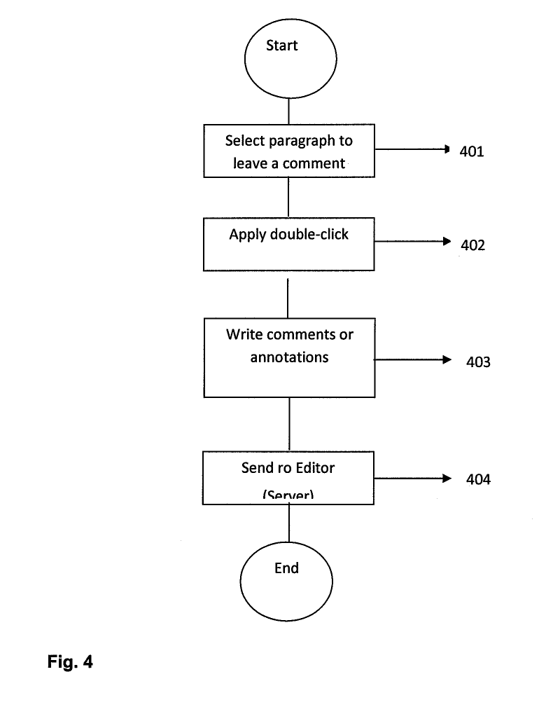

FIG. 4 shows the method used to write comments or annotations on certain parts of the consulted book. In the first place, in order to make a comment or an annotation, the user must select the paragraph for which the comment is intended to (401). Once the paragraph is selected, the user must double click over such paragraph (402) and proceed to write the comment (403) or annotation that he wishes to, writing it on the field destined for this purpose. After the user has written an opinion or comment about that specific part of the book, it is sent to the book's editor via Internet (404), who then reviews the comment and edits it on the server.

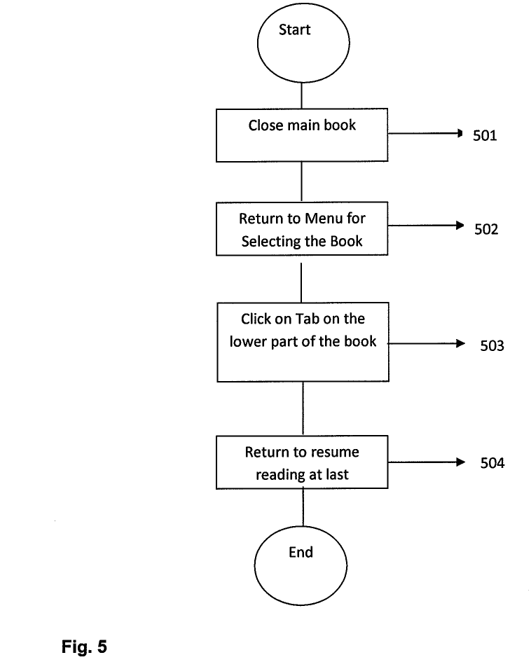

FIG. 5 shows the method used to close the book in a detailed manner, so that when the user opens it again, he can go back to the page where he was before. When the reader is in a particular page of the main book, he just clicks over the “close book” button (501). At this time, the book is closed and the computer program returns to the main Menu of the Book Selection (502). If the user decides to resume the book's reading, he would just have to click over the tab located under the book (503), which will open on the page where the user left (504) the last time he performed a consultation.

FIG. 6 refers to the visualization of the computer program's main menu of the present invention. This main menu comes with the appearance of a physical book to facilitate the user's interpretation. The work that is going to be consulted can be selected through this menu. These works are located on the titles' section (601). Before selecting the work, the user can find out partially about it because when the cursor is placed over the title, a review (602) is displayed. This main menu includes are Prologue tabs (603), which lead to another menu that displays all the different authors of prologues of the virtual book.

When the user has read the review and has decided the title of the work that he wishes to consult, he selects it from a list. Each title will display a new menu, characteristic of each of the different works found in the data base. This menu, shown in FIG. 7, displays the books related to the chosen title that are available. One of these books is the one that contains the entire work (701) in different languages and versions; another one is the book titled “Total Book” (702), through which the reader can return to the selection of the title of the work that he wishes to look up. Some of the other books available are mentioned next, along with an explanation of their content.

The “Reader's Book” (703) offers the reader the possibility of not being limited only to read texts from other authors, but it allows the user to create his own text, where he can include notes or comments written about certain specific parts of books that he has consulted. This book is also an agenda as well, where the user can copy some fragments of texts, meanings of words, etc.

As previously mentioned, a user can read other types of “Related Books” (704) which are directly linked to a specific work. One of these is the “Names and Places” book, which is characterized in that it mentions all the possible names and places related to the main work, and it shows in a detailed manner, the connection they have with it.

There is also a book that refers to the “Related Works”. This book shows all literary works that may have been inspired from the work being consulted. Furthermore, it mentions other types of texts such as stories or others related to some specific place or character that plays a role in the work.

The book that mostly stands out among these “Related Books” (704) is the “Iconography”, which is characterized for showing the different art works that are directly related with the main work. This book shows the works of different artists and is characterized in that it allows a detail view of them.

Last of all, the user can find a “Comments” book within the Related Books that, as it name indicates, contains comments from other authors with respect to the main work that is being consulted. These comments can be seen according to the author or all of them at the same time.

When the user selects the main book that contains the entire work, he will find a visualization of the open book as showed in FIG. 8. This visualization of the book includes a section where the user selects the Language and Version (801) in which he wants to consult such work. If the user has not selected the correct choice or, if he wishes to choose another book, he may return to the book's main menu through the small “close-book” tab (802). Once the language and version in which the user wishes to carry out the consultation have been selected, he finds an interface containing all the information sought, as shown in FIG. 9.

FIG. 9 shows the screen display of an open book, which is characterized in that it comprises several components. The system of the computer program shown in FIG. 9, presents a connection tab (901) which is characterized by the fact that when a double click is applied on one of these tabs, a text from the page that the user is visualizing is underlined. Based on this underlined text, the user can consult additional information, such as an image, a comment or a historical review related to the text that is being consulted. These tabs also allow the consultation of the book's index or allow the comparison of the current version of the text consulted with another version in the same language or in a different one. Furthermore, the user can select two languages and perform the reading of these two selected languages in a simultaneous manner.

The information selected will be displayed in a smaller book located over the one that is already open. This smaller-size book is shown in FIG. 10 and includes a central closing point (1001), an Index Tab (1002) that takes the user to the index of such book and displays all possible options included, and one or more tabs with the additional information available (1003).

A different component that characterizes the computer program system for the virtual book of the present invention is a “Back-Page” button, which as it names indicates, is characteristic for allowing the user to go back one page in the book that is being consulted through a simple click. If the button is pressed in a continued manner the user can go to a specific page number.

In FIGS. 8, 9, 10 and 11, the user can observe a Close-Book zone, (802, 903,101 and 1103 respectively). When interacting with this zone, the book is closed and the user goes back to the previous menu maintaining the page where he was before, so that when he enters the program again the reader can resume the reading on the same page where he was, for the case that the book being consulted is the one that contains the entire work. In the case of other books like the smaller ones shown in FIG. 10, such book is closed and allows the user to continue the reading of the main book.

The “Next-Page” button (904), allows the user to forward a page of the book that he is reading at that time through a click. Just like with the Back-Page button (902), if this button is pressed in a constant manner, the user can go to a specific page in a faster way.

The computer program system of the virtual book presents a Reading Listening zone or for Musical fragments (905), which allows the user to listen to a reading in a specific language or a musical fragment associated to the reading. Depending on the icon that appears on this zone, a balloon indicates Reading and a Quaver indicates Music.

FIG. 11 shows the dictionary that can be consulted when a word is selected, as illustrated in the method in FIG. 2. The dictionary includes a Words Section (1101) where the user can find the word selected from the book that was being consulted. In front of the Word Section (1101) there is the Meaning Section (1102) which shows the meaning of the word selected in the Words Section (1101).

The present invention shows some characteristics of the format described, among which an outstanding fact is that the user may listen to the reading of the text in the language chosen. Furthermore, he can listen to the reading of all the available translations of the main work. Additionally, different translations of the original work may be compared in a simultaneous manner.

The way in which several works are related showed by the computer program system of the virtual book described stands out, since the user can observe the works of different illustrators and, at the same time, he can relate them to the part of the work that these refer to.

Furthermore, the computer program of the virtual book allows the user to read the notes, comments and marginal annotations done by specialists of different times and places, who have written their comments corresponding to fragments or parts of specific literary texts. A supplement of this feature is that the readers are allowed to write their comments and recommendations to the editors of the texts that they are consulting.

Another characteristic of the computer program system for the virtual book of the present invention is the availability of historical reviews of the characters in an abbreviated, extended and detailed manner, allowing for the reading of their entire works when dealing with authors.

The literary works are not limited solely to writings inspired by a writer's imagination, but in addition, with the passing of time they have allowed other people to be inspired by them and multiple musical works may have derived therefrom. The computer program of the virtual book allows the user listen to these musical works that throughout history have derived from the text that he is consulting. It also allows the observation of the works of art that have been inspired by the literary work as well as the works of art in which the literary works have been inspired, showing the links between different literary works and art works.

The criteria search performed through the computer program of this virtual book, allows the user to find other complete works of different authors directly or indirectly related to the main work that is being consulted.

One of the advantages represented by the computer program of the virtual book is that it allows the knowledge of the meaning of words and their etymology, their synonyms and antonyms, and the variation of their meanings throughout time, since an intensive search is carried out not only in current dictionaries but also in dictionaries from different times, because the meaning of certain words is different depending on the time and context in which the word was initially used.

As the user reads the text, he may write down annotations to a page. The reader can be writing down his point of view or his comments regarding the reading done, or as the case may be, he can write down annotations related to corrections that can be done to the book itself.

However, the computer program for the virtual book is not limited to books or texts written by third parties only, but it also allows the user to create his own book, which can be comprised by annotations and fragments copied from a specific work, always observing copyrights.

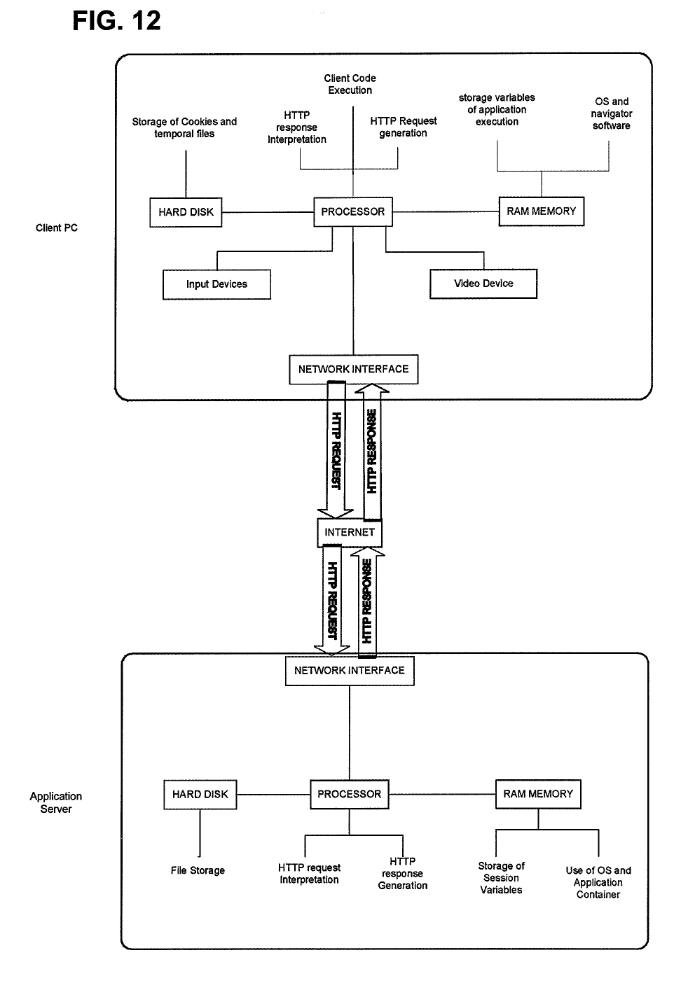

FIG. 12 illustrates a functional block diagram of the hardware resources used in a representative environment in which the present invention may be employed. More specifically, FIG. 12 shows the general use of the hardware resources in both the client machine and the applications server of the virtual book.

In a preferred embodiment, the client machine must be running a navigator type program. Through the navigator, HTTP requests are sent to the server; the server processes the requests and it sends back a series of HTTP answers that are interpreted by the navigator. The navigator program generates the visualization of the book on the visual display screen of the users computer.

The navigator also controls the execution of the JavaScript code of the application.

1. A method for the execution and visualization for a computer program of a virtual book, wherein comprises the following steps:
a. To execute the computer program
b. To visualize a user's interface
c. To visualize a review of a work
d. To select the work to be consulted
e. To select the book that is related to the work
f. To open the book selected
g. To select the starting page of the consultation
h. To advance page by page
i. To select the tools of consultation
j. To close the book consulted

2. A method for the execution and visualization for a computer program in accordance to claim 1, wherein such interface allows the visualization of the information of two pages of the book in the closest way as done with a physical book.

3. A method for the execution and visualization of a computer program in accordance to claim 1, wherein the visualization of the review is performed by moving the cursor over the title of the work.

4. A method for the execution and visualization of a computer program in accordance to claim 1, wherein the book selected is the main work.

5. A method for the execution and visualization of a computer program in accordance to claim 4, wherein it also includes the step of selecting the language and version of the work.

6. A method for the execution and visualization of a computer program in accordance to claim 1, wherein the selected book is another book from the collection, related to the chosen work.

7. A method for the execution and visualization of a computer program in accordance to claim 6, wherein the collection's books are a Complete Book, a Reader's Book, and Related Books.

8. A method for the execution and visualization of a computer program in accordance to claim 7, wherein the Association book is selected from the group that comprises: “Names and Places”, “Associated Works”, “Iconography”, “Comments”, and others related to the work selected.

9. A method for the execution and visualization of a computer program in accordance to claim 5, wherein the selection of the page may be done optionally by opening the index and by selecting one of the chapters listed therein.

10. A method for the execution and visualization of a computer program in accordance to claim 1, wherein the consultation tool to be selected is chosen from a group comprised by dictionaries, audio, comments and tools, located on the connection tabs.

11. A method for the execution and visualization of a computer program in accordance to claim 10, wherein the tools located in the connection tabs display a new and small book that includes the option chosen.

12. A method for the execution and visualization of a computer program in accordance to claim 11, wherein when the tools dictionary, comments and connection tabs are selected, a new and small book is opened, which offers the option to moving pages forward and backward, and after the consultation id done it closes allowing the continuation of the reading of the main book which was initially consulted.

13. A method for the execution and visualization of a computer program in accordance to claim 10, wherein the dictionary tool is executed and visualized by double clicking over the searched word, and when the dictionary book is open the word's language or context are chosen.

14. A method for the execution and visualization of a computer program in accordance to claimlo, wherein the audio tool is executed and visualized by double clicking over the balloon located on the high end of each page, starting the reading of the text in the corresponding language and the reading of the book's text is stopped by clicking on the same icon.

15. A method for the execution and visualization of a computer program in accordance to claim 10, wherein the audio tool is executed and visualized by double clicking over the Quaver icon located on the high end of each page, then musical work that the user wishes to hear is selected and the reproduction of such musical work is stopped by clicking on the same icon.

16. A method for the execution and visualization of a computer program in accordance to claim 10, wherein the comments tool is executed by selecting the paragraph for which the comment is made, double-clocking over such paragraph then leaving a comment through a writing on the field space destined for this purpose, to then send the comment via Internet to the book's editor who reviews the comment and edits it on the server.

17. A method for the execution and visualization of a computer program in accordance to claim 10, wherein the tools located on the tabs are executed by clicking over such tabs, which display an underlined text, from which the user can look up additional information by double-clicking over such word.

18. A method for the execution and visualization of a computer program in accordance to claim 17, wherein the tools located on the tabs are selected form the group comprising image, comment, a historical review and versions among others.

19. A method for the execution and visualization of a computer program in accordance to claim 18, wherein when the selected tool consists of versions, one of the versions is visualized on each page, allowing the comparison with the consulted text, in the same or different language.

20. A method for the execution and visualization of a computer program in accordance to claim 1, wherein the stage to close the book is done by clicking on the close button, located on the lower end, in the center of the consulted book.
